(19) United States
(12) Patent Application Publication
(10) Pub. No.: US 2013/0272832 A1
(43) Pub. Date: Oct. 17, 2013

(54) WORKSTATION FOR UNLOADING A PALLET

(71) Applicant: Laitram, L.L.C., Harahan, LA (US)

(72) Inventors: Stephen G. Wargo, Laurel, MD (US); Dane Briddell, Silver Spring, MD (US)

(21) Appl. No.: 13/914,300

(22) Filed: Jun. 10, 2013

Related U.S. Application Data
(63) Continuation-in-part of application No. 12/132,748, filed on Jun. 4, 2008.

(51) Int. Cl. B65G 65/00

(52) U.S. Cl. CPC B65G 65/00
USPC 414/639; 414/592

(57) ABSTRACT

A workstation to aid in the manual unloading of a pallet. The workstation comprises a work area bounded on tows ides by a pallet load platform, a takeaway conveyor, and two parallel conveyors. An operator standing in the work area removes pallet elements from the top layer of the pallet load and places them on one or the other parallel conveyors, which convey them to the takeaway conveyor. The parallel conveyors, which may be tilted gravity conveyors or powered conveyors, are hinged so that they can be raised to an open position allowing operator to enter or exit the work area. The pallet layer may be supported on a tilted scissor lift.

### CROSS-REFERENCE TO RELATED APPLICATIONS

This application is a continuation-in-part of co-pending U.S. patent application Ser. No. 12/132,748, filed Jun. 4, 2008, and incorporated into this application by reference.

### BACKGROUND

The invention relates generally to pallet-unloading workstations.

A typical pallet load comprises a multi-layer array of containers, such as boxes or trays, stacked atop a pallet. The containers are often removed manually from the pallet one by one starting with the topmost layer. Containers in the topmost layer closest to the point of removal are easy to remove. But containers farther away from the point of removal are hard to reach. And, once reached, they have to be moved to another location.

### SUMMARY

One version of a workstation for unloading pallet elements from a pallet load embodying features of the invention comprises a pallet platform for supporting a pallet load of pallet elements and a takeaway platform opposite the pallet platform. First and second conveyors are spaced apart and arranged to convey the pallet elements to the takeaway platform. The pallet platform, the takeaway platform, and the first and second conveyors each define one of the four sides of a work area for a human operator to remove pallet elements from the pallet platform and to place the pallet elements on the first or second conveyor to be conveyed to the takeaway platform.

Another version of a workstation for unloading a pallet load comprises a pallet platform for supporting a pallet load of pallet elements and a takeaway platform opposite the pallet load. A first conveyor extends from the pallet platform to the takeaway platform to convey the pallet elements to the takeaway platform. The pallet platform, the takeaway platform, and the first conveyor form three sides of a work area for a human operator. The first conveyor includes a hinge proximate the takeaway platform to allow the first conveyor to be moved from a closed position to an open position providing the human operator access into and out of the work area past the conveyor in the open position.

Another version of a workstation comprises a supply platform supporting a load of articles. First and second conveyors are spaced apart and arranged to convey the articles in a direction away from the supply platform. The supply platform and the first and second conveyors each define three sides of a work area for a human operator to remove the articles from the supply platform and to place the articles on the first or second conveyor to be conveyed away from the work area. At least one of the first and second conveyors is movable from a closed position conveying the articles to an open position allowing a human operator access into and out of the work area.

### BRIEF DESCRIPTION OF THE DRAWINGS

These features and aspects of the invention, as well as its advantages, are better understood by referring to the following description, appended claims, and accompanying drawings, in which:

FIG. 1 is a side elevation view of one version of a tiltable scissor lift for helping unload a pallet;

FIG. 2 is a top plan view of a portion of the scissor lift of FIG. 1; and

FIGS. 3A-3D are side elevation views of another version of a scissor lift as in FIG. 1 showing its operation;

FIGS. 4A and 4B are top plan and side elevation views of a workstation usable with a scissor lift as in FIG. 1 and embodying features of the invention, showing the workstation in a closed configuration; and FIGS. 4C and 4D show the workstation in an open configuration; and

FIGS. 5A and 5B are top plan and side elevation views of another version of a workstation as in FIGS. 4A and 4B showing the workstation in a closed configuration; and FIGS. 5C and 5D show the workstation in an open configuration.

### DETAILED DESCRIPTION

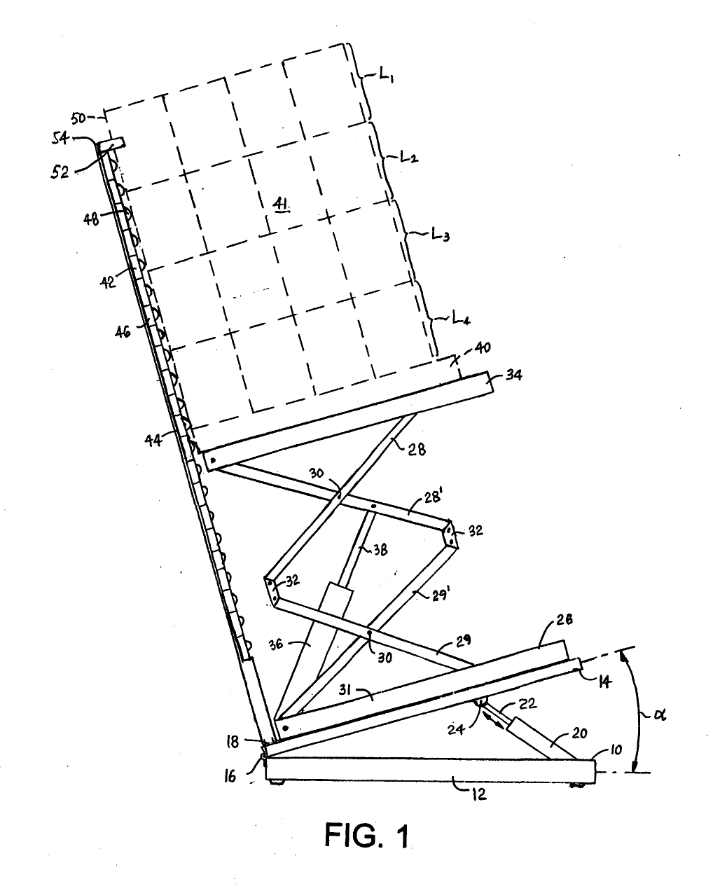

FIG. 1 shows an apparatus that helps unload a pallet load. The apparatus includes a tilter 10, such as one of those manufactured and sold by Vestil Manufacturing Corp. of Angola, Ind., U.S.A. The tilter has a base 12 to which a platform 14 is attached at a hinge 16 at first edge 18 of the platform. A hydraulic cylinder 20 is pivotally attached to the base at one end. A piston rod 22 at the other end is attached to the platform at a pivot 24. When the piston rod is completely retracted, the platform is horizontal. The extension of the rod determines the tilt angle a of the platform.

A lift 26, in the form of a scissor lift, such as one of those sold by Dumpers Unlimited of Bailey, Mich., U.S.A., is mounted to the tiltable platform. The scissor lift shown is a two-stage lift with two pairs of crossing legs 28, 28′, 29, 29′, joined at scissor pivots 30 and supported in a base 31. The legs in each pair are joined at knee joints 32. The lower inner leg 29′ is pivotally affixed to the base 31. The lower outer leg 29 is pivotally attached to a wheel (not shown) or other slidable mount that can translate along the base as the lift is being extended or retracted. A table 34 forms a top support surface of the lift. The upper inner leg 28′ is pivotally affixed to the underside of the table. The upper outer leg 28 is pivotally attached to a slidable mount (not shown). The lift is actuated by a hydraulic cylinder 36 pivotally attached to the base 26 at one end. A piston rod 38 at the other end is pivotally attached to the upper inner leg 28′.

A pallet 40 rests on the lift table 34. A multi-layer pallet load 41, comprising an arrangement of pallet load elements, such as containers, boxes, packages, cartons, trays, or bundles of mail, is supported on the pallet. The pallet load in this example has four layers L₁-L₄, where L₁ is the topmost layer.

A wall 42 extends upward from the lower edge of the tilted platform 14 of the tilter 10. The wall includes a support frame 44 backing an array 46 of rollers 48. One example of the roller array forming the wall is a modular roller-top conveyor belt mat, such as one of those manufactured and sold by Intralox, L.L.C. of Harahan, La., U.S.A. The modular belt mat is constructed of rows of conveyor belt modules linked side to side and end to end at joints between adjacent rows. Rollers on the belt are rotatable in the upward direction along the wall. Because of the rolling contact provided by the rollers, the wall serves as a low-friction restraining surface for the downwardly tilted side 50 of the pallet load. The wall prevents the pallet load from falling off the tilted table 34. The rollers allow the pallet load to advance easily as it bears against the rollers when the pallet is being lifted. This prevents scuffing or marring of labels on pallet load elements as well.

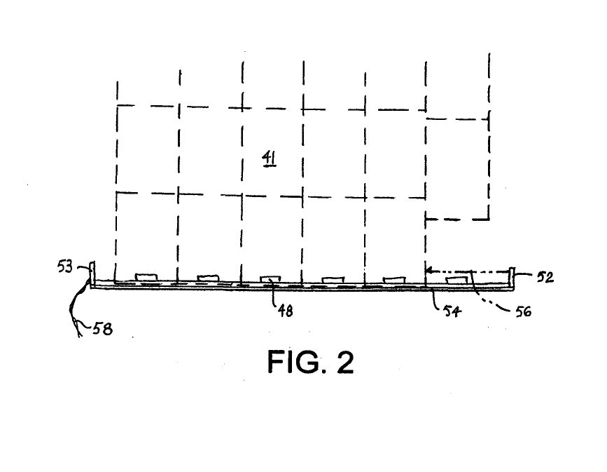

A sensor, such as an optical transmitter 52 and a receiver 53, are mounted at the distal top end 54 of the wall. As shown in FIG. 2, the optical transmitter transmits a light beam 56 from the right side of the top end of the wall towards the receiver at the left side along a path parallel and close to the confronting face of the wall. In this way, the sensor senses the presence of pallet load elements, such as trays, in the topmost layer. The light beam is positioned close to the wall because the tilt of the pallet load causes trays in the topmost layer to slide by gravity along the top of the next lower layer as in the topmost layer at the wall are removed. So, as long as at least one remains in the topmost layer, a tray should be in a position blocking the light beam. Once the final tray is removed from the topmost layer, the unoccluded light beam traverses the entire width of the wall and is received by the optical receiver, which sends a signal on signal wires 58 to activate the lift to advance the pallet layers to position the succeeding layer at the top end of the wall. The amount of advancement is preferably fixed to be the height of the pallet layers. But, in a closed-loop arrangement, the interruption of the light beam by the new topmost layer could be used to signal the lift to stop its advance.

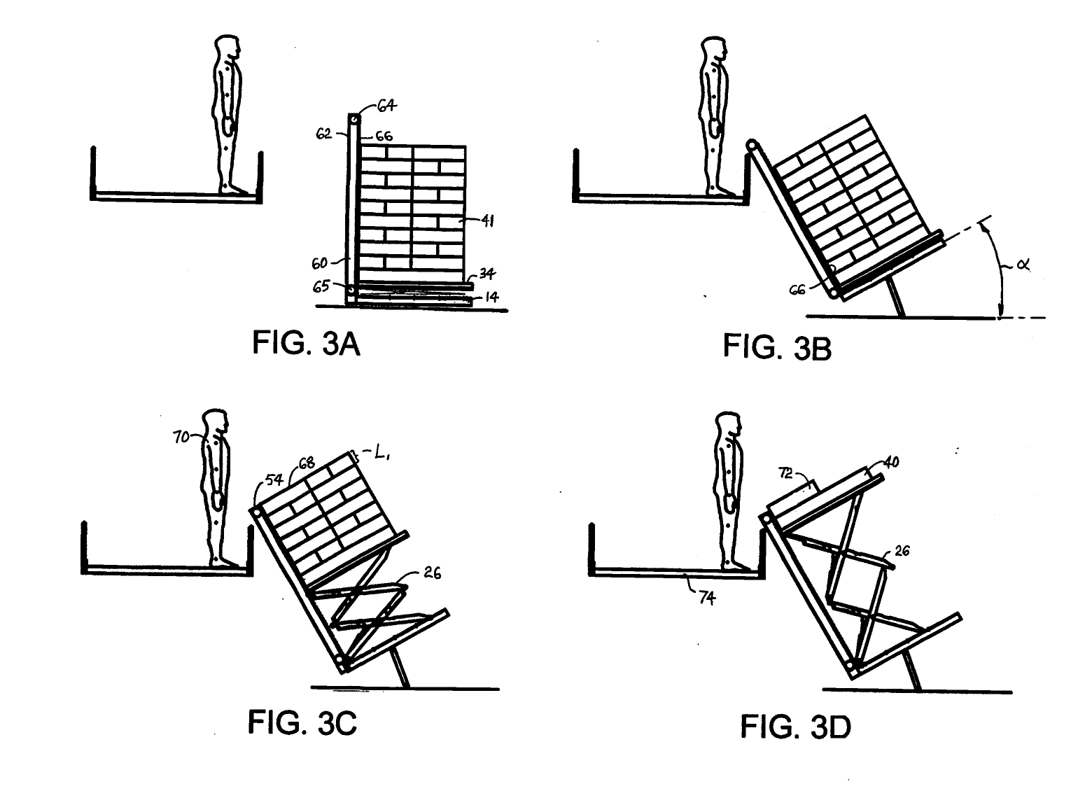

One method of unloading a pallet layer using an apparatus like that shown in FIGS. 1 and 2 is shown in FIGS. 3A-3D. This apparatus differs from the previous version in that it has a wall 60 realized as a belt loop 62 trained around a pair of divert sprockets or rollers 64, 65. The outer face 66 of the belt facing the pallet load presents a generally planar surface to receive the tilted pallet load. Both rollers may be idle rollers so that, as the pallet load is lifted, the belt advances along the rollers with the advance of the pallet load by contact. One of the divert rollers, such as the bottom roller 65, could be a powered roller driven by an internal or external motor in synchrony with the actuation of the lift to help lift the pallet load. By moving with the pallet load, both versions, powered and unpowered, effectively present a low-friction restraining surface to the pallet load.

The operational sequence begins in FIG. 3A with a pallet load 41 deposited atop the retracted lift's table 34 while the tilt platform 14 is in the horizontal position. As shown in FIG. 3B, the tilter 12 is activated to tilt its platform and, consequently, the lift and the pallet load at an angle α. When the pallet load is tilted, the load is urged by gravity against the supporting surface 66 of the wall, which serves as a restraint to the pallet load. As shown in FIG. 3C, the lift 26 is then activated to push the pallet load upward toward the top end 54 of the wall. In a preferred scheme, the lift stops when the top 68 of the topmost layer L₁ of the pallet load extends above the top end of the wall for easy access by an operator 70. But the lift could be operated to stop when the top layer is at a level convenient for an operator to reach, even if the top of the top layer is below the top end of the wall. The operator, shown standing on an elevated platform 74, manually removes pallet load elements, such as trays, from the topmost layer over the top end of the wall. The action of gravity on the trays in the topmost layer urges them toward the wall as leading trays are removed. In this way, the operator does not have to lean across the pallet layers to reach the far trays. For manual removal of the trays, the layers are lifted so that the bottom of the topmost layer is below the top end of the wall, which acts as a lip to retain the trays. But the lift could also be used for automatic removal by lifting the layers until the bottom of the topmost layer clears the top end of the wall and is automatically discharged over the top end by gravity onto an unloading device. As shown in FIG. 3D, the lift 26 continues to advance the pallet load and stop it as layers are removed. Once the last tray 72 of the last layer is removed from the pallet 39, the lift is retracted and the tilter's platform is returned to its horizontal position for removal of the pallet 40 before another pallet load is deposited on the tiltable lift.

The wall could be realized as a flat stationary wall, perhaps made of a slick hard plastic or other material that has a relatively low coefficient of friction for easy sliding. The operator could use a manual lift control to activate the lift to position the pallet load as required, instead of using the topmost-layer position sensor. And sensors other than the optical sensors described could be used to determine the complete removal of a pallet layer. For example, limit switches positioned along the top end of the wall could be used to react to the pressure of pallet load elements with a signal indicating the complete removal of the layer. As yet another example, the lift could be realized as other than a scissor lift. A lift table pushed directly by a piston rod or by a telescoping rod or any other conventional lift mechanism could be used in the tiltable lift of the invention.

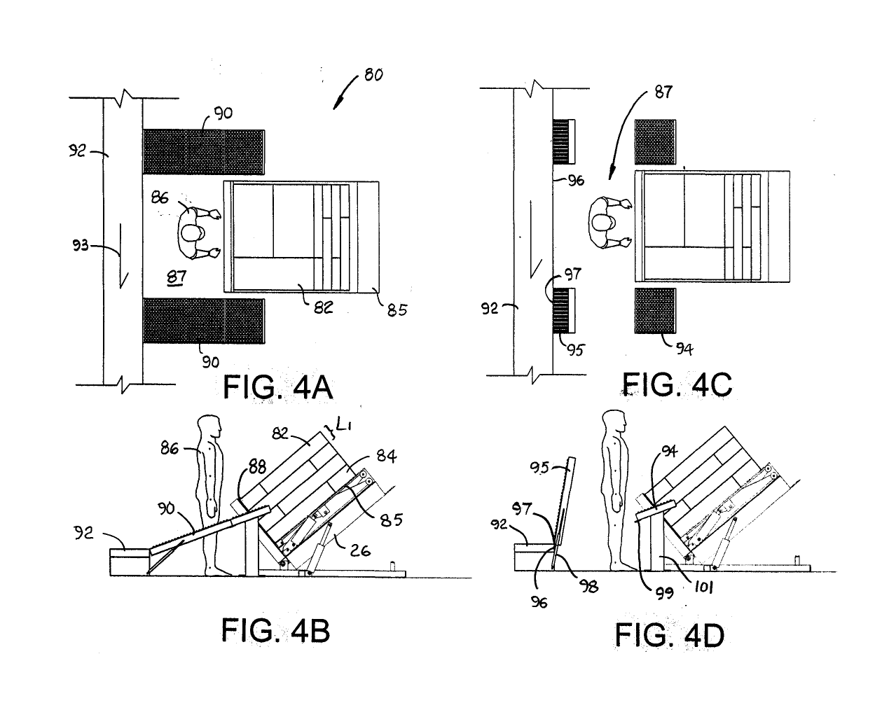

One version of a workstation embodying features of the invention is illustrated in FIGS. 4A-4D. The workstation 80 is designed to facilitate the removal of articles, such as pallet load elements 82, from a pallet load 84. The pallet load shown in FIGS. 4A-4D is supported on a pallet platform 85 of a tiltable scissor lift 26. But the pallet load 84 could be supported on other kinds of article-support platforms. An operator 86 stands in a work area 87 at the lower end 88 of the pallet platform 85 of the scissor lift 26. Flanking the operator 86 are two gravity conveyors 90. Each gravity conveyor 90 is tilted downward from the pallet load 84 to a takeaway platform, such as a table or a takeaway conveyor 92 advancing in a conveying direction 93 to transport the removed pallet items further downstream. The takeaway conveyor can be realized as a flat belt, a slat conveyor, a roller conveyor, or a modular plastic conveyor belt or chain with or without embedded rollers. The scissor lift 26, the gravity conveyors 90, and the takeaway conveyor 92 form the four sides of the enclosed work area 87. The two gravity conveyors 90, 91 can be arranged parallel to, as shown, or diverging from each other. Each gravity conveyor 90 has either a smooth, low-friction upper surface or a plurality of freely rotatable rollers. The operator 86 removes individual pallet elements 82 from the top pallet layer L₁ and places them on one or the other of the gravity conveyors 90. The gravity conveyors are spaced apart from each other across the work area by a distance small enough to allow the operator, standing midway between both conveyors, to place the pallet elements onto either gravity conveyor. The pallet elements 82 slide or roll down the gravity conveyors 90 by gravity and onto the takeaway conveyor 92. As already described, when pallet elements are removed from the top layer L₁ on the scissor lift 26, they are replaced by other elements in the layer that slide down toward the lower end 88 of the pallet platform.

As shown in FIGS. 4B and 4D, each of the gravity conveyors 90 is separable into an upper section 94 and a lower section 95. The lower section 95 is connected to a lower support, such as the frame 96, of the takeaway conveyor 92 by a hinge 97. Lift supports 98 connected between the lower support 96 and the lower section 95 hold the lower section in a raised position, as in FIGS. 4C and 4D, when the lower section is moved by the operator to provide access to and from the work area 87. The shorter upper section 94 remains in place, supported on a stand 101. A tab 99 extending from the lower end of the upper section supports the confronting upper end of the lower section when the workstation is in the closed configuration of FIGS. 4A and 4B. As an alternative, the upper section 94 could be made longer and outfitted with a hinge and lift support instead of or in addition to the lower section 95. The hinge could alternatively be arranged to be lowered rather than raised into the open position—or even to pivot like a gate about a vertical hinge axis.

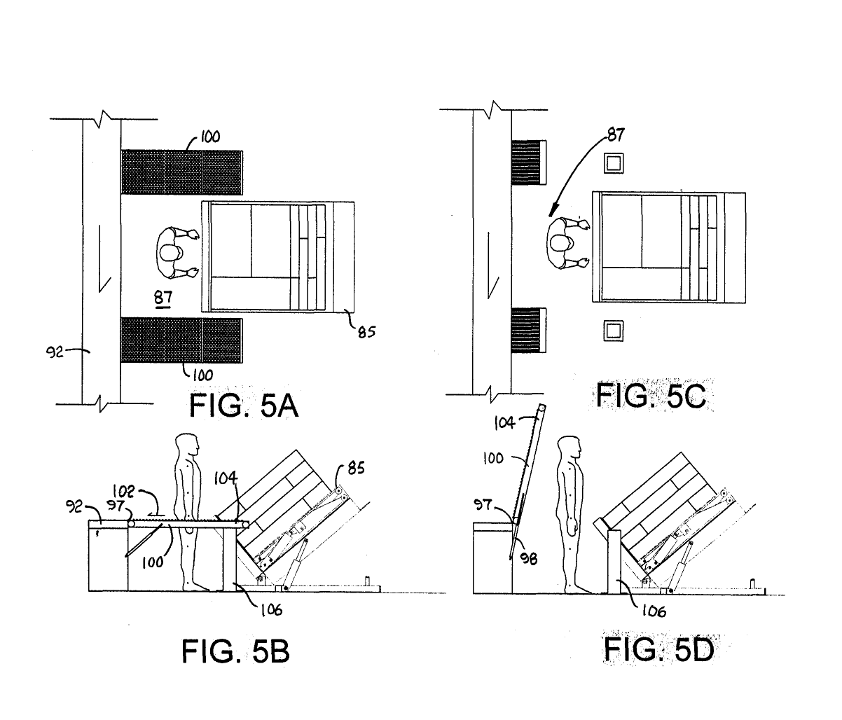

Another version of a pallet-unloading workstation is shown in FIGS. 5A-5D in closed and open configurations. The only difference between this version and the version of FIGS. 4A-4D is that the gravity conveyors 90 of FIGS. 4A-4D are replaced by powered conveyors 100. The powered conveyors 100 may be realized by a conveyor belt advancing in a conveying direction 102 away from the pallet support 85 and toward the takeaway conveyor 92 or by powered rollers rotating to convey pallet elements in the conveying direction 102. The conveyor belt can be, for example, a flat belt, a slat belt, or a modular plastic belt or chain with or without embedded rollers. Like the gravity conveyors 90, the powered conveyors 100 have hinges 97 and lift supports 98 to allow the powered conveyors to be lifted to provide access into and out of the work area 87. The non-hinge ends 104 of the powered conveyors 100 are supported on stands 106. Unlike the gravity conveyors, the powered conveyors do not have to be tilted when closed.

What is claimed is:

1. A workstation for unloading pallet elements from a pallet load, comprising:
a pallet platform for supporting a pallet load of pallet elements;
a takeaway platform opposite the pallet platform;
first and second conveyors spaced apart and arranged to convey the pallet elements to the takeaway platform;
wherein the pallet platform, the takeaway platform, and the first and second conveyors each define one of the four sides of a work area for a human operator to remove pallet elements from the pallet platform and to place the pallet elements on the first conveyor or the second conveyor to be conveyed to the takeaway platform.

2. A workstation as in claim 1 wherein the first and second conveyors are gravity conveyors.

3. A workstation as in claim 1 wherein the first and second conveyors are powered conveyors.

4. A workstation as in claim 1 wherein the first and second conveyors include rollers supporting the pallet elements.

5. A workstation as in claim 1 wherein the first and second conveyors are parallel to each other.

6. A workstation as in claim 1 wherein the first and second conveyors are separated across the work area by a distance short enough so that a human operator standing at a position in the work area midway between the first and second conveyors can place pallet elements onto either of the first and second conveyors from that position midway between the first and second conveyors.

7. A workstation as in claim 1 wherein at least one of the first and second conveyors includes a hinge proximate the takeaway platform to allow the at least one of the first and second conveyors to be raised from a closed position to an open position providing a human operator access into and out of the work area.

8. A workstation as in claim 7 wherein the at least one of the first and second conveyors includes a lift support holding the at least one of the first and second conveyors in the open position.

9. A workstation as in claim 1 wherein the first and second conveyors are each formed of two separable sections.

10. A workstation as in claim 1 wherein the takeaway platform is a conveyor conveying products away from the workstation.

11. A workstation as in claim 1 wherein the pallet platform comprises a tiltable scissor lift.

12. A workstation for unloading pallet elements from a pallet load, comprising:
a pallet platform for supporting a pallet load of platform elements;
a takeaway platform opposite the pallet platform;
a first conveyor extending from the pallet platform to the takeaway platform to convey the pallet elements to the takeaway platform;
wherein the pallet platform, the takeaway platform, and the first conveyor form three sides of a work area for a human operator; and
wherein the first conveyor includes a hinge proximate the takeaway platform to allow the first conveyor to be moved from a closed position to an open position providing a human operator access into and out of the work area past the first conveyor in the open position.

13. A workstation as in claim 12 wherein the first conveyor includes a lift support holding the raised first conveyor in the open position.

14. A workstation as in claim 12 wherein the first conveyor is formed of two separable sections.

15. A workstation as in claim 12 further comprising a second conveyor extending from the pallet platform to the takeaway platform to convey the pallet elements to the takeaway platform and forming a fourth side of the work area.

16. A workstation as in claim 12 wherein the first conveyor is a gravity conveyor.

17. A workstation as in claim 12 wherein the first conveyor is a powered conveyor.

18. A workstation for unloading articles from a supply platform, comprising:
a supply platform for supporting a load of articles;
first and second conveyors spaced apart and arranged to convey the articles in a direction away from the supply platform;
wherein the supply platform and the first and second conveyors each define three sides of a work area for a human operator to remove the articles from the supply platform and to place the articles on the first conveyor or the second conveyor to be conveyed away from the work area; and
wherein at least one of the first and second conveyors is movable between a closed position conveying the articles and an open position providing the human operator access into and out of the work area.

19. A workstation as in claim 18 further comprising a takeaway conveyor forming a fourth side of the work area and receiving the articles from the first and second conveyors to convey the articles away from the work area.

20. A workstation as in claim 18 wherein the supply platform is a pallet platform supporting layers of the articles forming a pallet load.
